(19) United States
(12) Patent Application Publication
(10) Pub. No.: US 2025/0223163 A1
(43) Pub. Date: Jul. 10, 2025

(54) CARBON NITRIDES WITH HIGHLY CRYSTALLINE FRAMEWORK AND PROCESS FOR PRODUCING SAME

(71) Applicant: The University of Newcastle, Callaghan (AU)

(72) Inventors: Ajayan Vinu, Newcastle (AU); Jae-Hun Yang, Newcastle (AU); Mohammed Fawaz Palakkat Alihassan, Newcastle (AU)

(73) Assignee: The University of Newcastle, Callaghan (AU)

(21) Appl. No.: 19/044,426

(22) Filed: Feb. 3, 2025

Related U.S. Application Data
(63) Continuation of application No. PCT/AU2022/050842, filed on Aug. 4, 2022.

(51) Int. Cl. C01B 21/06; B01J 27/24; B01J 35/39

(52) U.S. Cl. CPC C01B 21/0605; B01J 27/24; B01J 35/39; C01P 2002/72; C01P 2002/82; C01P 2002/84; C01P 2006/12

(57) ABSTRACT

A highly crystalline mesoporous sulphur functionalized carbon nitride and a process for producing the same. The process including the steps of: providing a carbon nitride precursor material; mixing the carbon nitride precursor material with a metal salt to form a first mixture; and, thermally treating the first mixture to produce the crystalline carbon nitride.

### CROSS-REFERENCE TO RELATED APPLICATIONS

This application is a continuation of, and claims priority to and the benefit of, PCT International Application No. PCT/AU2022/050842, filed Aug. 4, 2022 and entitled “CARBON NITRIDES WITH HIGHLY CRYSTALLINE FRAMEWORK AND PROCESS FOR PRODUCING SAME,” which is hereby incorporated by reference herein.

### TECHNICAL FIELD

The present invention generally relates to carbon nitrides with highly crystalline framework, and in particular to heteroatom functionalised mesoporous and non-porous carbon nitrides with highly crystalline framework which find application for hydrogen generation from seawater. The present invention relates to a process for producing such carbon nitrides with highly crystalline framework.

### BACKGROUND

Global energy consumption has grown at a rapid rate of 2.3% since the year 2000 and is expected to reach 22TW in 2030. The ongoing major source of this energy is fossil fuels which account for more than 80% of global energy consumption. Energy derived from fossil fuels involves the emission of a large amount of CO₂ and other toxic air contaminants to the earth's atmosphere, which have been shown to cause global warming as well as adverse effects on human health. The release of CO₂ into the atmosphere is predicted to increase over the next several decades through the large-scale consumption of fossil fuels and is also predicted to cause catastrophic environmental damage posing a significant threat to society.

New technologies that can produce clean energy from renewable energy sources seek to address the above environmental challenges and to meet the growing energy demand.

Carbon nitrides (CN) are excellent candidates to complement nanocarbons and have the advantages of unique electronic structure, the intrinsic bandgap of ˜2.7 eV, Lewis basic functionalities, hydrogen bonding motifs, high chemical and thermal stabilities, and excellent chemical resistance. To date, five different carbon nitrides have been identified, which include α-C₃N₄, β-C₃N₄, cubic-C₃N₄, pseudo-cubic C₃N₄, and g-C₃N₄. Among these carbon nitride, g-C₃N₄, whose structure is similar to graphitic nanostructure, can be prepared by molecular or chemical precursors at low temperature or pressure conditions. This carbon nitride has unique semiconducting and Lewis basic properties and offers a wide range of application possibilities in energy storage and conversion. Although this material exhibits unique properties, it suffers from poor specific surface area, pore volume and ordered porous structure.

In recent times, there has been some success in introducing mesoporosity into the carbon nitride, g-C₃N₄ nanostructure resulting in mesoporous carbon nitride (MCN-1) with an ordered porous structure, high specific surface area and large pore volume. However, the performance of the MCN in semiconducting applications is limited to the MCN framework with a small bandgap.

By varying the nitrogen contents and the chemistry and the structure of the carbon nitride precursors, a series of non-porous and mesoporous carbon nitride with C₃N₅, C₃N₆, C₃N₇ and C₃N₈ stoichiometries with different chemical structures have been successfully produced. These materials have been found to have a variety of potential uses including for photocatalytic seawater splitting, energy storage and conversion, heterogeneous catalysis and carbon capture and conversion. However, one of the major issues in these materials is their amorphous carbon nitride framework. The poor crystallinity significantly affected the performance of these materials in various applications, including the photocatalytic splitting of seawater.

Photocatalytic water splitting is one of the most efficient techniques for converting water molecules into hydrogen and oxygen fuels by photoexcited electron-hole pairs generated on the surface of semiconducting photocatalysts using sunlight and water. Several photocatalysts including semiconducting metal oxides such as titanium dioxide, metal phosphides, metal oxides, metal nitrides and metal oxynitrides have been used as photocatalysts for the generation of hydrogen through photocatalytic water splitting.

The water-splitting potential of non-porous carbon nitride with amorphous wall structure under visible light was realized as early as 2009. Unfortunately, the activity of these materials was found to be low owing to their amorphous wall structure and the lack of the number of active sites due to low specific surface area.

The preferred embodiments of the present invention seek to provide highly crystalline carbon nitride nanostructures to address one or more of these disadvantages, and/or to at least provide the public with a useful alternative.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### SUMMARY

This summary is provided to introduce a selection of concepts in a simplified form that are further described below in the Detailed Description. This summary is not intended to identify essential features of the claimed subject matter, nor is it intended to be used to limit the scope of the claimed subject matter.

According to one aspect, there is provided a process for the preparation of a crystalline carbon nitride including the steps of:
a. providing a carbon nitride precursor material;
b. mixing the carbon nitride precursor material with a metal salt to form a first mixture; and,
c. thermally treating the first mixture to produce the crystalline carbon nitride.

In certain embodiments, the carbon nitride precursor is selected from: thiourea, urea, aminoguanidine hydrochloride, diaminotriazine, diaminotriazole, 5,5-Dithiobis(1-Phenyl-1H-Tetrazole), dithiooxamide, and 3-amino-1,2,4-triazole. In one form, the carbon nitride precursor is thiourea.

In certain embodiments, the metal salt is selected from: potassium chloride, sodium chloride, magnesium chloride, lithium chloride or a mixture thereof.

In certain embodiments, the carbon nitride precursor is mixed with the metal salt to form the first mixture in a weight ratio of about 4:0.5 to about 4:10. In one form, the carbon nitride precursor is mixed with the metal salt to form the first mixture in a weight ratio of about 4:2 to about 4:5. In a further form, the carbon nitride precursor is mixed with the metal salt to form the first mixture in a weight ratio of about 4:3.

In certain embodiments, the first mixture is thermally treated during step c. at a temperature ranging from about 450° C. to about 700° C. In one form, the first mixture is thermally treated during step c. at a temperature ranging from about 500° C. to about 600° C. In a further form, the first mixture is thermally treated during step c. at a temperature of about 550° C.

In certain embodiments, the first mixture is thermally treated during step c. for a period of time ranging from 1 hour to about 8 hours. In one form, the first mixture is thermally treated during step c. for a period of time ranging from 3 hours to about 5 hours. In a further form, the first mixture is thermally treated during step c. for about 4 hours.

In certain embodiments, the crystalline carbon nitride produced in step c. is washed with an acidic solution to remove alkaline salts and by-products. In one form, the acidic solution includes hydrochloric acid.

In certain embodiments, mixing the carbon nitride precursor material with a metal salt to form a first mixture is in a dry form in step b.

In certain embodiments, a soft templating technique or a hard templating technique is used to increase the mesoporosity of the crystalline carbon nitride. In one form, the soft templating technique or the hard templating technique is employed during step b.

In certain embodiments, the hard templating technique utilises mesoporous silica nanoparticles. In one form, the mesoporous silica is added to the mixture including the carbon nitride precursor material with the metal salt in a colloidal solution at step b. In one form, the colloidal solution includes water. In a further form, the colloidal solution is evaporated resulting in the first mixture in the form of a dry powder prior to step c.

In certain embodiments, the step of thermally treating the first mixture is conducted in an atmosphere selected from nitrogen, argon, helium or is conducted under vacuum.

According to another aspect, there is provided a highly crystalline mesoporous sulphur functionalized carbon nitride with S_{BET} (m²/g) of between about 40 and about 70 m²/g. In one form, the highly crystalline mesoporous sulphur functionalized carbon nitride with S_{BET} of about 60 m²/g.

According to another aspect, there is provided a crystalline carbon nitride produced from the process as herein described.

According to another aspect, there is provided a use of the carbon nitride as herein described as a photocatalyst for the production of hydrogen. In one form, the production of hydrogen is from saline water including from seawater.

### BRIEF DESCRIPTION OF FIGURES

Example embodiments are apparent from the following description, which is given by way of example only, of at least one non-limiting embodiment, described in connection with the accompanying figures, in which:

FIG. 1 is powder X-ray diffraction patterns for sulphur containing highly crystalline carbon nitrides with a new crystal structure synthesized from thiourea with KCl depending on the reaction time;

FIG. 2 is UV-Vis spectra for carbon nitrides with a new crystal structure synthesized from thiourea with KCl depending on the reaction time;

FIG. 3 is Fourier transform infrared spectra for SCCNs with a new crystal structure synthesized from thiourea with KCl depending on the reaction time;

FIG. 4 is C K-edge, N K-edge and S L-edge NEXAFS spectra of for SCCN-TU samples together with gCN and gCN-TU;

FIG. 5 is photocatalytic H₂ evolution from water containing 10 vol % triethanolamine under solar simulator light irradiation equipped with 1.5 G air-mass filter for SCCN with a new crystal structure depending on the reaction time at 550° C.;

FIG. 6 is powder X-ray diffraction patterns for mesoporous CN with a new crystal structure synthesized from thiourea with KCl via a hard template method together with SCCN-TU-4h and gCN-TU;

FIG. 7 is UV-Vis spectra for MSCCN-TU with a new crystal structure synthesized from thiourea with KCl via a hard template method together with SCCN-TU-4h and gCN-TU;

FIG. 8 is photocatalytic H₂ evolution from water containing 10 vol % triethanolamine under solar simulator light irradiation equipped with 1.5 G air-mass filter for mesoporous SCCN-TU with a new crystal structure together with SCCN-TU and gCN-TU;

FIG. 9 is X-ray diffraction patterns for carbon nitrides with a new crystal structure synthesized from urea with KCl depending on the reaction time;

FIG. 10 is UV-Vis spectra for SCCN-U-1h together with gCN-U;

FIG. 11 is photocatalytic H₂ evolution from water containing 10 vol % triethanolamine under solar simulator light irradiation equipped with 1.5 G air-mass filter for CCN-Us with a new crystalline carbon nitride structure together with gCN-U;

FIG. 12 is X-ray diffraction patterns for mesoporous CCN-ATs with a new crystalline structure synthesized from 3-amino-1,2,4-triazole with KCl via a hard template method together with CCN-AT-4h and gCN-AT;

FIG. 13 is UV-Vis spectra for mesoporous carbon nitrides with a new crystal structure synthesized from 3-amino-1,2,4-triazole with KCl via a hard template method together with CCN-AT-4h and gCN-AT;

FIG. 14 is N₂ adsorption isotherms and BJH pore-size distribution curves for MCCN-ATs with a new crystalline carbon nitride structure synthesized from 3-amino-1,2,4-triazole with KCl via a hard template method together with CNN-AT-4h;

FIG. 15 is photocatalytic H₂ evolution by MCCN-ATs, CCN-AT-4h and gCN-AT from water containing 10 vol % triethanolamine under solar simulator light irradiation equipped with 1.5 G air-mass filter (0.1 W/cm²);

FIG. 16 is X-ray diffraction patterns for CCN-AG with a new crystal structure synthesized from aminoguanidine hydrochloride in KCl salt with and without SiO2 nanoparticles together with CCN-AG-4h and gCN-AG;

FIG. 17 is UV-Vis spectra for CCN-AG-4h and MCCN-AG with a new crystal structure synthesized from aminoguanidine hydrochloride in KCl salt with and without SiO2 nanoparticles together with gCN-AG;

FIG. 18 is N₂ adsorption isotherms and BJH pore-size distribution curves for carbon nitrides with a new crystal structure synthesized from aminoguanidine hydrochloride in KCl salt with and without SiO₂ nanoparticles;

FIG. 19 is photocatalytic H₂ evolution from water containing 10 vol % triethanolamine under solar simulator light irradiation equipped with 1.5 G air-mass filter for carbon nitrides with a new crystal structure synthesized from aminoguanidine hydrochloride in KCl salt with and without SiO₂ nanoparticles;

FIG. 20 is photocatalytic H₂ evolution of SCCN-TU-4h in different salt waters such as 0.5M NaCl(aq), 0.25M K₂HPO₄(aq) and 0.5M KI(aq) together with pure water containing 10 vol % triethanolamine under solar simulator light irradiation equipped with 1.5 G air-mass filter;

FIG. 21 is photocatalytic H₂ evolution of SCCN-TU-4h together with commercial photocatalyst (P25) and gCN in pure water and 0.5M NaCl(aq) containing 10 vol % triethanolamine under solar simulator light irradiation equipped with 1.5 G air-mass filter;

FIG. 22 is photocatalytic H₂ evolution of SCCN-TU-4h in different concentration of Pt used as a cocatalyst in 10 vol % TEA in 0.5M NaCl(aq) under solar simulator light irradiation equipped with 1.5 G air-mass filter;

FIG. 23 is photocatalytic H₂ evolution of SCCN-TU-4h in different concentration of triethanolamine in 0.5M NaCl(aq) under solar simulator light irradiation equipped with 1.5 G air-mass filter;

FIG. 24 is photocatalytic H₂ evolution of SCCN-TU-4h loaded with 3 wt % Pt in the sea water collected in different area near Newcastle (Australia) containing 20 vol % triethanolamine under solar simulator light irradiation equipped with 1.5 G air-mass filter; and,

FIG. 25 is photocatalytic H₂ evolution of SCCN-TU-4h and MSCCN-TU loaded with 3 wt % Pt in the simulated sea water (0.5M NaCl(aq) containing 20 vol % triethanolamine under solar simulator light irradiation equipped with 1.5 G air-mass filter.

### DETAILED DESCRIPTION

The following modes, given by way of example only, are described in order to provide a more precise understanding of one or more embodiments.

It was found that by introducing the crystallinity in the semiconducting framework of a functionalized carbon nitride nanostructure with different nitrogen contents, chemical structures and morphologies, a new family of carbon nitride nanostructures with unique semiconducting and electronic properties was identified. In addition, this new family of carbon nitride nanostructures was found to enhanced performance in photocatalytic hydrogen generation and other energy storage and conversion applications.

In accordance with embodiments described herein, the highly crystalline and functionalized carbon nitride framework was produced via a “salt moulding approach” in which metal salts are used. Without wishing to be bound by theory, it is thought the metals salts not only help to enhance the polymerization of carbon nitride precursors by connecting the molecules and assisting cross-linking, but also prevent the decomposition of carbon nitride precursors at high temperatures. In addition, it is also understood the ions of the metal salts may assist to increase the surface area and thereby increase the crystallinity of the final carbon nitride materials.

The highly crystalline carbon nitride materials produced in accordance with embodiments described herein when utilised in photocatalytic hydrogen generation from saline water including seawater include vacant sites that are created by the alkali metal salts and which then capture the alkali metal ions from the saline water. It is thought these ions assist to increase the charge transfer kinetics and also suppress the electron-hole recombination to enhance the photocatalytic activity of saline water splitting.

The highly crystalline carbon nitride materials produced in accordance with embodiments described herein may also include heteroatoms such as sulphur into the carbon nitride framework which is understood to create intra-band-gap states close to the conduction band edges for enhancing the visible light splitting of saline water. The performance may be further increased by creating mesoporosity in these unique crystalline functionalized carbon nitride materials as the mesoporosity provides more active sites.

Splitting of saline water such as sea water with visible sunlight is considered a challenging process owing to the large concentration of alkali salts in the water, which suppress the activity of photocatalysts. By using the highly crystalline CN materials produced in accordance with embodiments described herein, these issues may be overcome as the proposed materials appear to offer vacant sites together with the porosity which may capture these alkali ions and activate the catalysts.

In accordance with certain embodiments, there is provided a process for the preparation of a crystalline carbon nitride including the steps of: providing a carbon nitride precursor material; mixing the carbon nitride precursor material with a metal salt to form a first mixture; and, thermally treating the first mixture to produce the crystalline carbon nitride.

The carbon nitride precursor may be selected from any suitable precursor material which includes significant quantities of carbon and nitrogen. In a preferred form the carbon nitride precursor further includes a significant quantity of a heteroatom such as sulphur. In preferred forms, the carbon nitride precursor may be selected from: thiourea, urea, aminoguanidine hydrochloride, diaminotriazine, diaminotriazole, 5,5-dithiobis(1-phenyl-1H-tetrazole), dithiooxamide, and 3-amino-1,2,4-triazole.

The metal salt may be selected from any suitable metal salt. In a preferred form, the metal salt is selected from: potassium chloride sodium chloride, lithium chloride, magnesium chloride and the mixture of these chlorides. The mixtures of the different metal chlorides may be made with different molar ratios.

In certain embodiments, the first mixture including the carbon nitride precursor material with a metal salt may be thermally treated at a temperature ranging from about 450° C. to about 700° C. In a preferred form, the temperature may range from about 500° C. to about 600° C. In a further preferred form, the temperature is about 550° C.

The thermal treatment may be for a period of time ranging from 1 hour to about 8 hours. In a preferred form, the thermal treatment may be for a period of time ranging from 3 hours to about 5 hours. More preferably, the thermal treatment may be for about 4 hours.

In certain embodiments, the crystalline carbon nitride produced by thermally treating the first mixture of carbon nitride precursor material with a metal salt may be washed with an acidic solution to remove alkaline salts and by-products. The acidic solution may be selected from any suitable acidic solution such as for example a solution of hydrochloric acid.

In certain embodiments, the process as herein described may include a soft templating technique or a hard templating technique to increase the mesoporosity of the crystalline carbon nitride so produced.

As herein described the term “soft templating” refers to a direct synthesis of the porous carbon nitride materials, with block copolymers or surfactants being employed as structure-directing agents leading to the construction of the desired mesoporosity of the crystalline carbon nitrides so produced.

As herein described the term “hard templating” refers to the fabrication of porous materials with a stable porous structure by depositing the targeted materials into the confined spaces of the template, resulting in a reverse replica of the template. The structure replication may utilise porous “hard templates” including mesoporous silica or carbon.

In certain embodiments, the soft templating technique or the hard templating technique is employed during the mixing of the carbon nitride precursor material with the metal salt to form the first mixture. For example a hard templating technique includes mesoporous silica added to the mixture including the carbon nitride precursor material the metal salt in a colloidal solution including water. The colloidal solution may then be evaporated resulting in the first mixture in the form of a dry powder prior to step c.

In another example, colloidal silica nanoparticles of different sizes with different structures and pore diameters may be used as a structure-directing agent in a hard templating technique.

After the formation of the carbon nitrides using a hard and/or soft templating technique, the templates may be removed by 5 wt % of Hydrofluoric acid (HF) or NaOH solution.

In certain embodiments, the soft templating technique may include the use of polystyrene particles with different sizes or other polymeric surfactants with different molecular weights as structure-directing agents. These structure-directing agents are mixed with carbon nitride precursor and the metal salt to form an aqueous homogeneous solution, and the water is slowly evaporated. Then, the mixture may be thermally treated at 550° C. to form the mesoporous new crystalline carbon nitride structure.

In certain embodiments, sulphur containing highly crystalline carbon nitride with a new crystal structure may be synthesized from thiourea (TU) and potassium chloride. Thiourea is a organosulphur compound which is single molecular precursor and offers a large amount of C, N, and S for the direct synthesis of sulphur-containing highly crystalline carbon nitride.

In certain embodiments, urea may be used as a carbon nitride precursor containing C, N and O. By using this precursor, new carbon nitride with novel crystal structure may be synthesized by using salt moulding technique.

The present invention will become better understood from the following examples of preferred but non-limiting embodiments thereof.

### Examples

The present invention will become better understood from the following examples of preferred but non-limiting embodiments thereof.

Materials: Synthesis of Carbon Nitride with a Novel Crystal Structure SCCN from Thiourea (SCCN-TU)

6.0 g of thiourea (TU) as carbon nitride precursor was mixed and ground with 4.47 g (60 mmol) of potassium chloride (KCl). Different samples were prepared by varying the carbonization time from 1 to 6 h. The mixture of TU and KCl was calcined at 550° C. for different times (1, 2, 3, 4 and 6 h). Then, the obtained yellowish powder was washed with 2 M HCl and deionized hot water together with ethanol to remove the alkaline salt and by-products. The filtered particles were re-dispersed in 300 mL of deionized water at around 60° C. under stirring for 20 min, and then filtered and washed with water and ethanol. The final materials were denoted as SCCN-TU-xh, where x denotes the thermal-polymerization time in hours. For the comparison with SCCN-TU synthesized via alkaline salt moulding method, bulk graphitic carbon nitride was synthesized without any KCl and calcined at 550° C. for 4 h. The prepared sample is denoted as gCN-TU.

### Mesoporous SCN-TU

Silica nanoparticles with uniform size were used in line with a hard templating technique to make mesoporous carbon nitrides with a new crystal structure. 6.0 g of TU was dissolved in 30 mL of deionized water at 60° C. 5 g of Ludox HS-40 (40% SiO₂ nanoparticle with 12 nm size) colloidal solution and 4.47 g (60 mmol) of KCl were added to this solution under stirring at 60° C. till the clear solution is formed. Subsequently, the water was slowly evaporated, resulting in the white powder. The resulting white powder was ground and calcined at 550° C. in a muffle furnace under the nitrogen atmosphere for 3 h. The obtained yellowish product was washed with 2 M HCl and deionized hot water together with ethanol to remove the alkaline salt and by-products. The filtered yellowish power was re-dispersed and stirred in 300 mL of 5 wt % HF (aq) for removing the silica template. The resulting suspension was then filtered and washed with water and ethanol. The filtered powders were dried at 100° C. for 12 h. The final materials are denoted as MSCCN-TU.

CCN from Urea (CCN-U)

8.0 g of urea as carbon nitride precursor is mixed and grounded with and 4.47 g (60 mmol) of KCl. The mixture of urea and KCl is calcined at 550° C. for 1 h. The obtained yellowish powder is washed with 2 M HCl and deionized hot water together with ethanol to remove the alkaline salt and by-products. The filtered particles were re-dispersed in 300 mL of deionized water at around 60° C. under stirring for 20 min, and then filtered and washed with water and ethanol. In order to completely remove the alkaline salt, the washing process was carried out one more time. The final materials are denoted as CCN-U-1h. The effect of the thermal-polymerization time was not studied as the samples decomposed when the thermal-polymerization time was more than 1 h. For the comparison with CCN-U synthesized via alkaline salt molding method, bulk graphitic carbon nitride was synthesized prepared by calcining 8 g of urea at 550° C. for 4 h without any KCl and the prepared sample is denoted as gCN-U.

CCN from 3-Amino-1,2,4-Triazole (CCN-AT)

3.0 g of 3-amino-1,2,4-triazole (AT) as carbon nitride precursor was mixed and ground with 5.96 g (80 mmol) of potassium chloride (KCl). The mixture was calcined at 550° C. for 3 h, 4 h and 6 h. The obtained yellowish powder is washed with 2 M HCl and deionized hot water together with ethanol to remove the alkaline salt and by-products. The filtered particles were re-dispersed in 300 mL of deionized water at around 60° C. under stirring for 20 min, and then filtered and washed with water and ethanol. In order to completely remove the alkaline salt, this washing process was carried out one more time. The final materials are denoted as CCN-AT-xh where x denotes the thermal-polymerization time in hour. For the comparison with CCN-AT synthesized via alkaline salt moulding method, bulk graphitic carbon nitride was synthesized prepared by calcining 3 g of 3-aminotriazole at 550° C. for 4 h, which is denoted as gCN-AT.

Mesoporous carbon nitride with a new crystal structure was synthesized via a hard template method. 3.0 g of 3-aminotriazole as carbon nitride precursor was dissolved in 35 mL of deionized water at 60° C. 3.75 g or 7.00 g of Ludox HS-40 (40% SiO₂ nanoparticle with 12 nm size) colloidal solution and 5.96 g (80 mmol) of KCl are added to this solution under stirring at 60° C., to a clear solution. Then the water was slowly evaporated under stirring, resulting in the white powder. The resulting white powder was ground and calcined at 550° C. in a muffle furnace under the nitrogen atmosphere for 4 h. The obtained yellowish product is washed with 2 M HCl and deionized hot water together with ethanol to remove the alkaline salt and by-products. The filtered yellowish power is re-dispersed and stirred in 150 mL of 5 wt % HF (aq) for removing the silica template. The resulting suspension is then filtered and washed with water and ethanol. The filtered powders are dried at 100° C. for 12 h. The final materials are denoted as MCCN-AT-1 for 3.75 g of Ludox and MCCN-AT-2 for 7.00 g of Ludox.

CCN from Aminoguanidine Hydrochloride (CCN-AG)

Aminoguanidine hydrochloride (AG) is a non-aromatic and non-cyclic CN precursor with a low amount of C and a high nitrogen content and was used to make a carbon nitride with a crystal structure. 9.0 g of aminoguanidine hydrochloride (AG) was mixed and ground with and 4.47 g (60 mmol) of potassium chloride (KCl). The mixture of urea and KCl is calcined at 550° C. for 4 h. The obtained yellowish powder was washed with 2 M HCl and deionized hot water together with ethanol to remove the alkaline salt and by-products. The filtered particles were re-dispersed in 300 mL of deionized water at around 60° C. under stirring for 20 min, and then filtered and washed with water and ethanol. In order to completely remove the alkaline salt, the washing process was carried out one more time. The final materials are denoted as CCN-AG-4h. For the comparison with CCN-AG synthesized via alkaline salt molding method, bulk graphitic carbon nitride was synthesized by calcining 9 g of aminoguanidine hydrochloride at 550° C. for 4 h, which is denoted as gCN-AG.

Mesoporous carbon nitride with a new crystal structure may be also synthesized via a hard template method. 9.0 g of AG as carbon nitride precursor was dissolved in 35 mL of deionized water at 60° C. 5 g of Ludox HS-40 (40% SiO₂ nanoparticle with 12 nm size) colloidal solution and 4.47 g (60 mmol) of KCl were added to this solution under stirring at 60° C. till a clear solution was formed. The water was then slowly evaporated, resulting in the white powder. The resulting white powder is ground and calcined at 550° C. in a muffle furnace under the nitrogen atmosphere for 4 h. The obtained yellowish product is washed with 2 M HCl and deionized hot water together with ethanol to remove the alkaline salt and by-products. The filtered yellowish power is re-dispersed and stirred in 200 mL of 5 wt % HF (aq) for removing the silica template. The resulting suspension was then filtered and washed with water and ethanol. The filtered powders were dried at 100° C. for 12 h. The final materials are denoted as MCCN-AG.

### Characterization

### Physico-Chemical Properties

The crystal structure of the various synthesized carbon nitrides was characterized by using Powder X-ray diffraction (PXRD). PXRD patterns of all the samples were recorded with Panalytical Empyrean X-ray diffractometer equipped with Cu-Kα radiation (λ=1.5418 Å) and with Galipix Detector at 40 kV and 40 mA. A continuous scan mode was employed in a wide angle range (2θ=5-60°). The optical property of the carbon nitride was evaluated from the UV-Vis diffuse reflectance spectroscopic method. Fourier transform infrared (FT-IR) spectra were obtained with a Perkin Elmer Frontier FTIR/NIR spectrometer by the KBr disk method. The spectra were recorded with Perkin Elmer Lambda 1050+. Quantification of C and N of the samples was carried out with a Perkin Elmer EA 2400 Elemental Analyzer. The porous textures such as specific surface area and total pore volume were investigated by N₂ adsorption-desorption isotherm analysis at liquid nitrogen temperature by using ASAP 2040. The samples were degassed under vacuum (10⁻⁵ torr) at 200° C. for 24 h before the measurement.

### Photocatalytic Reaction

The photocatalytic reactions were carried out in a top-irradiation Pyrex reactor connected to a closed gas circulation and evacuation system. 0.1 g of the sample was dispersed in 100 mL of 10 Vol % triethanolamine aqueous solution as a hole scavenger under stirring in a reactor. The Pt cocatalyst (Pt/catalyst=3 wt %) was in-situ photo deposited on the functionalized carbonitride photocatalyst in the suspension during the photocatalytic reaction. In order to completely remove the air in the suspension, the reaction vessel was evacuated several times, and Ar gas was introduced to the reactor up to ˜50 torr. The suspension was irradiated with the solar simulated light with 1 sun power using a Newport Class ABB solar simulator equipped with 450 W Xe lamp and 1.5 G air mass filter through a water filter to cut the infrared light. The reaction temperature was maintained at 25° C. by keeping the reactor in the water jacket controlled by a circulating chiller system. The evolved gas was periodically analysed through the in-situ auto-injection system of a gas chromatograph (PerkinElmer Clarus 580 GC) equipped with TCD detector and stainless-steel column packed with Molecular Sieve 5 A, where Ar gas was used as a carrier gas.

### Results and Discussion

SCCN from Thiourea (SCCN-TU)

Sulphur functionalized crystalline carbon nitride with a new crystal structure can be successfully synthesized from thiourea and KCl via controlling the reaction time at 550° C.

### Dependency of Reaction Time at 550° C.:

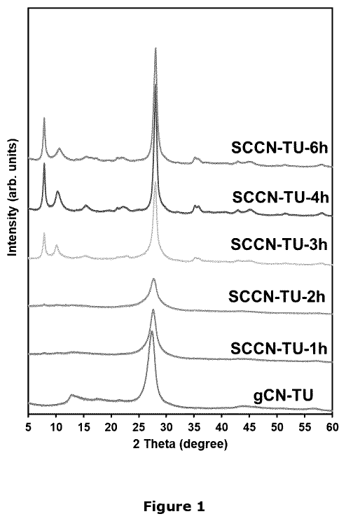

As can be seen in the FIG. 1, SCCN-TU-4h sample shows a completely different XRD pattern from the graphitic carbon nitride synthesized from thiourea (gCN-TU) prepared without KCl. The peaks at ˜13° and 27.3° corresponding to broad (110) and (002) peaks of graphic carbon nitride were not observed for NCNTU-4h. On the other hand, narrow and sharp peaks were observed at 7.86°, 10.10°, 28.01°, etc, indicating that sulphur-containing carbon nitride with new crystal structure was formed from thiourea and KCl. Without wishing to be bound by theory, it is assumed that KCl forms a eutectic phase with an intermediate compound from thiourea at 550° C., which can suppress the decomposition of the polymerized form of the thiourea and supports the reaction between the thiourea molecules to promote polymerization. This results in a different crystal structure from g-C₃N₄. The cell parameters for CCN-TU-4h is determined to be a=11.53 Å, b=7.75 Å, c=10.36 Å and β=105.7°, V=890.2 Å³ based on monoclinic symmetry. It may be observed that the transformation of CCN crystal structure depending on the reaction time via PXRD analysis. It should be noted that the sample prepared at 550° C. with the reaction time of 1 h exhibits the structure of a graphitic carbon nitride, but the (002) peak at ˜27.3° was slightly high-angle shifted compared to that of gCN-TU. However, as the reaction time increases to 2 h, the new XRD peaks corresponding to SCN with a new crystal structure starts to appear. After 3 h, the new peaks are well developed, and the peaks corresponding to gCN disappear. The SCCN maintains its new high crystalline structure for the thermal-polymerization time of 3-6 h. These results indicate that the thermal treatment time plays a role in controlling the final crystal structure of these materials. It is believed that the change in the crystal structure as a function of time is linked with the rate of polymerization of the thiourea molecules and the crystallization process. The reaction time of 1 hour may not be enough for the complete crystallization of the formed polymeric structure. As the added salts provide enough shield to avoid the decomposition of the polymeric structure, increase in the reaction time helps to obtain a highly crystalline SCCN framework. CHNS analysis revealed that the SCCN-TU contains a small amount of S in the crystalline carbon nitride framework, which is key for enhancing the charge transfer kinetics. The amount of the S content of the samples is in the range of 0.2-0.3 wt %.

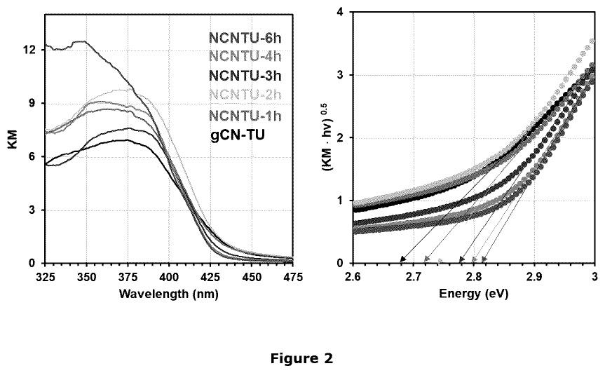

The optical property of SCN-TU was analysed by the UV-Vis spectrophotometer and the spectra are shown in FIG. 2. With increasing the reaction time from 1 to 6 h, the absorption edge was blue shifted. The band gaps of SCCN-TU-1h, SCCN-TU-2h, SCCN-TU-3h, SCCN-TU-4h and SCCN-TU-6 are determined to be 2.72 eV, 2.74 eV, 2.78 eV, 2.80 eV and 2.8 eV, respectively, which are larger than that of gCN-TU (2.72 eV). The absorbance of SCCN-TU is much higher than that of the gCN-TU, revealing the ability of SCCN-TU to absorb more light due to its highly ordered and crystalline structure.

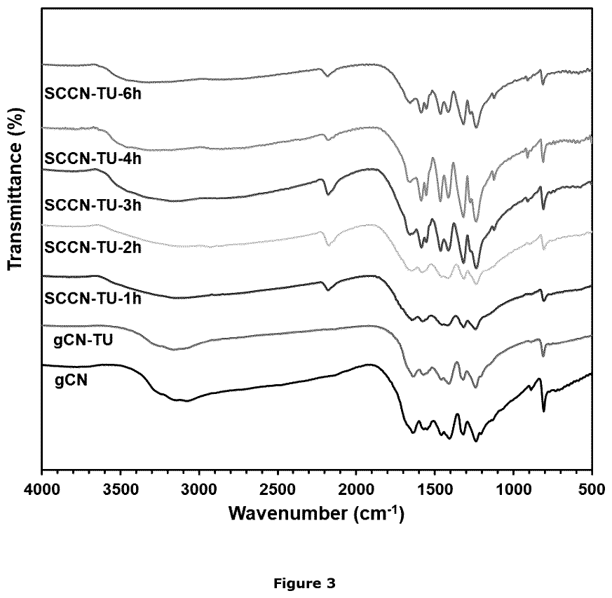

Functional groups of SCCN with a new crystal structure were analyzed by Fourier transform infrared spectroscopy (FT-IR) and the data are shown in FIG. 3 with graphitic carbon nitrides (gCN and gCN-TU). The vibrational bands for all SCCN-TUs samples together with gCN-TU are similar to that of the typical gCN, indicating that functional groups of gCN are also present in SCCN-TUs. The weak and broad peak in the range of 3000-3400 cm⁻¹ is assigned to N—H stretching vibration mode, indicating that small portion of —NH₂ or —NH groups are present in the crystal edge of SCCN-TUs, gCN and gCN-TU. However, we can only observe the broad peaks for SCCN-TUs between 3400 and 3600 cm⁻¹ corresponding to the —OH vibration band due to adsorbed water molecule in SCCN-TUs. Typically, the stretching and bending vibration peaks for the heterocyclic heptazine ring in gCN are observed between 1200 and 1650 cm⁻¹ and at 812 cm⁻¹. The presence of these bands in the SCCN-TUs indicates that heptazine-ring based chemical structures are formed in SCCN-TU samples. SCCN-TU samples also show a peak at ˜2200 cm⁻¹ corresponding to —N—C═N— vibration band.

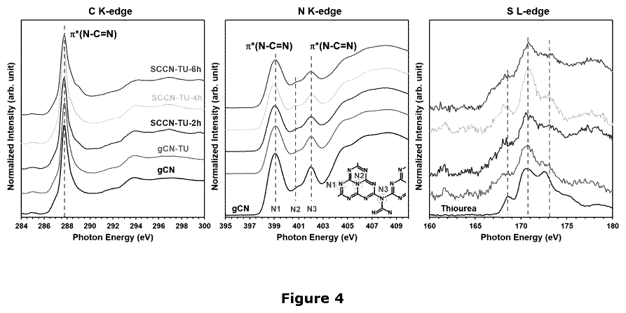

In addition, the local structure of the SCCN-TU samples was also analysed by using near edge absorption fine structure spectroscopy (NEXAFS). C K-edge, N K-edge and S L-edge NEXAFS spectra for SCCN-TU samples together with the reference samples such gCN and gCN-TU are plotted in FIG. 4. C K-edge spectra for the SCCN-TU samples are almost similar to those of gCN and gCN-TU. The peak at 287.9 eV is corresponding to π*(N—C═N) transitions, indicating that heterocyclic N—C═N bonds are present in the SCCN-TU samples. In addition, the strong peaks at 399.2 and 402.2 eV and a weak shoulder peak at around 401.0 eV in N K-edge spectra are observed in SCCN-TU samples as well as in gCN and gCN-TU. These three peaks are assigned to the heterocyclic N atoms between C atoms in heptazine hetero-ring (N1 position at 399.2 eV), sp³ N atom bridged with 3 C atoms among heptazine units (N3 position at 402.2 eV) and the central N atom in the heptazine (N2 position at 401.0 eV), respectively. These results reveal that heptazine based units are present in the SCCN-TU structure, which is similar to that of the theoretically predicted structure of gCN. These data are in good agreement with those of FT-IR analysis. It should be mentioned that the S content in the SCCN-TU is low, and therefore, it is difficult to detect the S in SCCN-TU and gCN-TU. However, the presence of S atom in the SCCN-TU samples is clearly observed in the S L-edge NEXAFS spectra. The peaks at 167.8 eV, 170.9 and 173.2 eV are detected in those samples, and the peak position is slightly shifted from that of pristine thiourea. This is due to the fact that the S atoms are doped in the heterocyclic position. This result confirms that S atoms are successfully doped in the SCCN with a new crystalline structure.

TABLE 1
The porous textures, C/N atomic ratios and photocatalytic H₂ evolution
activity of carbon nitrides with a new crystal structure synthesized
from thiourea and KCl depending on the reaction time at 550° C.

| | | | | Photocatalytic H₂ evolution activity | |
|---|---|---|---|---|---|
| | Porous texture | | carbon | | Amount of H₂ |
| | S_{BET} | Vₜₒₜ | nitride | Evolution rate | evolved in 5 h |
| Samples | (m²/g) | (mL/g) | ratio | (μmol g⁻¹h⁻¹) | (μmol/g) |
| SCCN-TU- | 4 | 0.01 | C₃N_{4.5} | 431 | 1822 |
| 1 h | | | | | |
| SCCN-TU- | 4 | 0.01 | C₃N_{4.4} | 886 | 3786 |
| 2 h | | | | | |
| SCCN-TU- | 6 | 0.01 | C₃N_{4.4} | 1484 | 6108 |
| 3 h | | | | | |
| SCCN-TU- | 11 | 0.03 | C₃N_{4.3} | 2741 | 10826 |
| 4 h | | | | | |
| SCCN-TU- | 22 | 0.09 | C₃N_{4.3} | 2010 | 8019 |
| 6 h | | | | | |
| gCN-TU | 13 | 0.07 | C₃N_{4.6} | 372 | 1668 |

The textural properties such as the specific surface area and the total pore volumes of the synthesized samples are analysed from the N₂ adsorption-desorption isotherm analysis. The values are summarized in Table 1. The BET (Brunauer-Emmett-Teller) specific surface area and pore volume of SCCN-TU-4h are 11 m²/g and 0.03 mL/g, which is almost the same as those of gCN-TU (11 m²/g and 0.07 mL/g). The specific surface area (22 m²/g) and the specific pore volume (0.09 mL/g) are slightly increased when the reaction time is increased from 4 h to 6 h.

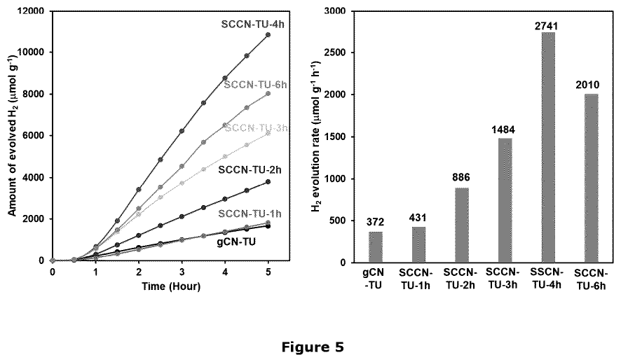

The photocatalytic activity of carbon nitride for H₂ evolution is strongly dependent on its crystal structure and reaction time. The photocatalytic H₂ evaluation of the synthesized catalyst loaded with 3 wt % Pt as a cocatalyst is carried out in 100 mL of 10 Vol % triethanolamine aqueous solution under the solar simulated light with 1 sun power. The result is plotted in FIG. 5. All the tested carbon nitrides samples can produce H₂ gas after 1 h of light irradiation and the hydrogen production is increased with increasing the irradiation time. The H₂ production rate is low within 1 h since the initially photo-generated electrons are consumed for reducing Pt⁴⁺ ions in the solution to form Pt metal as a cocatalyst on the surface of carbon nitride photocatalyst. Before the structural transformation to a new crystal structure, the photocatalytic activity for H₂ evolution of SCCN-TU-1h (431 μmol·g⁻¹h⁻¹) shows almost similar activity to that of gCN-TU since the crystal structure of both samples are similar. However, SCCN-TU-2h (886 μmol·g⁻¹h⁻¹) with a small portion of new crystal structure shows a significantly higher H₂ evolution rate than that of gCN-TU (372 μmol·g⁻¹h⁻¹). SCCN-TU-4h (2741 μmol·g⁻¹h⁻¹) registers remarkably higher activity than gCN-TU by almost 741%, while the specific surface area of SCCN-TU-4h (11 m²/g) is almost similar to that of gCN-TU (13 m²/g), indicating that SCCN with a new crystal structure can efficiently produce H₂ from water under the solar simulated irradiation. With increasing the reaction time to 6 h, the H₂ production rate of SCCN-TU-6h (2010 μmol·g⁻¹h⁻¹) decreases compared to that of SCCN-TU-4h. SCCN-TU-1h, SCCN-TU-2h, SCCN-TU-3h, SCCN-TU-4h and SCCN-TU-6h can photocatalytically produce 1822 μmol·g⁻¹, 3786 μmol·g⁻¹, 6108 μmol·g⁻¹, 10826 μmol·g⁻¹ and 8019 μmol·g⁻¹ of H₂ from water in 5 h, respectively, which are much higher than that of gCN-TU (1668 μmol·g⁻¹).

### Mesoporous SCCN-TU (MSCCN-TU)

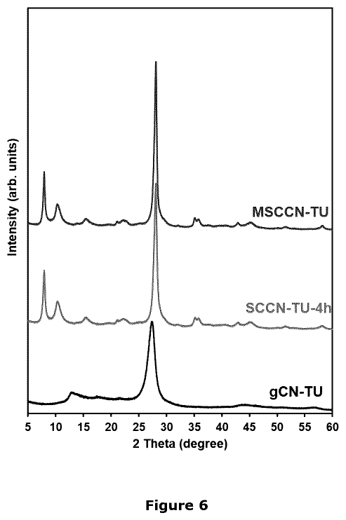

Sulfur functionalized mesoporous carbon nitrides with a new crystal structure can be synthesized from thiourea with KCl via a hard template method by using silica nanoparticles. The XRD patterns are plotted in FIG. 6. The XRD pattern of the final product (MSCCN-TU) is almost similar to that of SCCN-TU-4h with a new crystalline structure, which is different from that of gCN-TU. It is expected that the hard templating approach assisted by the silica nanoparticles may offer mesoporosity after the removal of the template. This result indicates that a new crystalline SCCN-TU with a mesoporous structure can be successfully synthesized from thiourea via the hard template method.

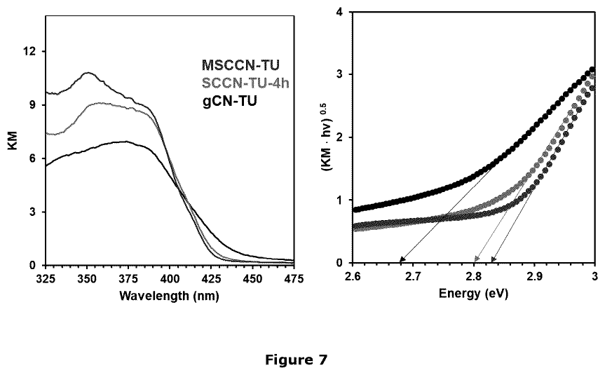

UV-Vis spectroscopic analysis was carried out to analyse the optical property of MSCCN-TU with a new crystal structure synthesized from thiourea and KCl via the hard template method, and the spectra are plotted in FIG. 7. MSCCN-TU shows a slight blue-shift of absorption edge compared with SCCN-TU-4h and bulk graphitic carbon nitride synthesized from thiourea. The band gap of MSCCN-TU is calculated to be 2.83 eV, which is a little larger than that of SCCN-TU-4h (2.80 eV) and gCN-TU (2.68 eV). However, the absorbance of MSCCN-TU is significantly higher than those of CCNTU-4h and gCN-TU, revealing that the mesoporosity in the sample assists to effectively absorb more irradiated light.

TABLE 2
The comparison of the textural parameters, C/N atomic ratios and
photocatalytic H₂ evolution activity of MCCN-TU with a new crystal
structure synthesized from thiourea and KCl depending on the
reaction time at 550° C. with SCCN-TU-4 h and gCN-TU.

| | | | | Photocatalytic H₂ evolution activity | |
|---|---|---|---|---|---|
| | Porous texture | | carbon | | Amount of H₂ |
| | S_{BET} | Vₜₒₜ | nitride | Evolution rate | evolved in 5 h |
| Samples | (m²/g) | (mL/g) | ratio | (μmol · g⁻¹h⁻¹) | (μmol · g⁻¹) |
| MSCCN-TU | 61 | 0.09 | C₃N_{4.4} | 3590 | 14693 |
| SCCN-TU- | 11 | 0.03 | C₃N_{4.3} | 2741 | 10826 |
| 4 h | | | | | |
| gCN-TU | 13 | 0.07 | C₃N_{4.6} | 372 | 1668 |

The specific surface area, the specific pore volume and the photocatalytic hydrogen evolution activity are given in Table 2. The BET (Brunauer-Emmett-Teller) specific surface area and pore volume of MSCCN-TU are 61 m²/g and 0.09 mL/g, which is larger than those of SCCN-TU-4h (11 m²/g and 0.03 mL/g) and gCN-TU (13 m²/g and 0.07 mL/g). As can be seen in the adsorption isotherm, the amount of nitrogen adsorbed at the lower and higher relative pressure for MSCCN-TU is much higher than that of the SCCN-TU-4h and gCN-TU, revealing a significant enhancement in the specific surface area and the specific pore volume. The specific surface area of MSCCN-TU is 5.5 times larger than that of SCCN-TU-4h, indicating that the porous texture is successfully formed via a hard template method. This is also clearly reflected by the fact the nitrogen adsorption isotherm of the MSCCN-TU is well-defined type IV with a sharp capillary condensation step. This also confirms the presence of mesoporosity in the MSCCN-TU sample. This is the first report on the highly crystalline mesoporous sulphur functionalized carbon nitride. It should be noted that the size of the mesopores can be tuned by adjusting the size of the silica nanoparticles used as the templates. In this case, the size of the pores is almost similar to the size of the silica nanoparticles used. Similarly, various other mesostructured CCN-TU can be prepared by varying the nature of the silica templates. For example, mesoporous silica templates such as SBA-15, KIT-6, SBA-1, SBA-16, KIT-5, and MCM-48 can be used to make MCCN-TU with different mesoporous structures and pore diameters.

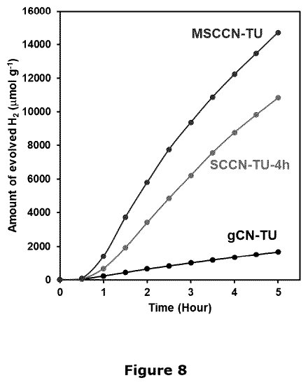

The photocatalytic activity of carbon nitride for H₂ evolution strongly depends on their porous texture and crystal structure. The photocatalytic H₂ evaluation of the synthesized catalyst loaded with 3 wt % Pt as a cocatalyst is carried out in 100 mL of 10 Vol % triethanolamine aqueous solution under the solar simulated light with 0.1 W/cm². As displayed in FIG. 8, MSCCN-TU registers the H₂ production rate of 3590 μmol·g⁻¹h⁻¹ which is remarkably higher than that of SCCN-TU-4h (2741 μmol·g⁻¹h⁻¹) and gCN-TU (372 μmol·g⁻¹h⁻¹). This result indicates that the photocatalytic H₂ evolution activity of carbon nitride with new crystal structure can be enhanced with the introduction of mesoporous structure in the carbon nitride framework. In addition, MSCCN-TU can produce 14693 μmol·g⁻¹ of H₂ from water in 5 h, which are larger than those of SCCN-TU-4h (10826 μmol·g⁻¹) at of gCN-TU (1668 μmol·g⁻¹). This high photocatalytic activity of MSCCN-TU is originated from the high light absorption property and the reduced recombination of produced charge carriers the due to the high crystalline structure together with the increased surface active sites due to the porous structure. It is also expected that the synthesis approach for introducing the mesoporosity creates a lot of defect sites that are highly favorable for suppressing the electron-hole recombination and further improves the charge transfer kinetics. Integrating several factors, including the higher specific surface area, sulphur doping, high crystallinity, mesoporosity and the defect sites, significantly supports the enhancement of the final photocatalytic generation of hydrogen.

SCCN from Urea (SCCN-U)

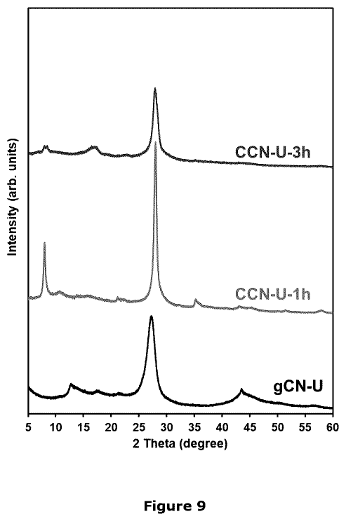

Urea can form the carbon nitride with a new crystal structure by the calcination with KCl at 550° C. for 1 h. According to the X-ray diffraction analysis (FIG. 9), SCCN-U-1h shows a completely different XRD pattern from graphitic carbon nitride synthesized from urea (gCN-U). Broad (110) and (002) peaks at ˜13° and 27.3° of gCN-U are not seen in the XRD patterns of SCCN-U-1h, and narrow and sharp peaks are observed at 7.86°, 10.10°, 28.01°, etc., which are similar to that of SCCN-TU-4 as shown in FIG. 1, indicating the formation of carbon nitride with new crystal structure from urea. However, these peaks are more broadened for SCCN-U-3h, indicating that the structure of SCCN-U is not stable at 550° C. for 3 h calcination condition.

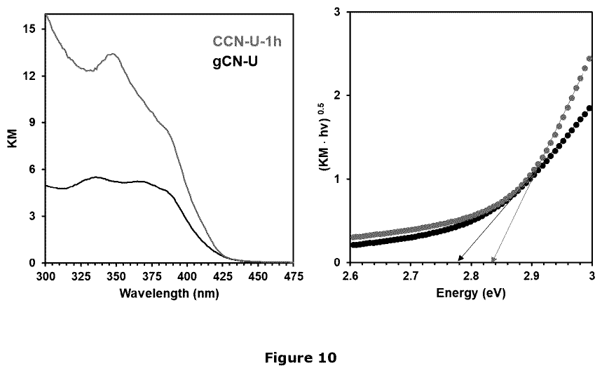

The optical property of SCCN-U-1h with a new crystal structure is analysed by the UV-Vis spectrophotometer and its UV-Vis spectrum is plotted with that of gCN-U, and the results are shown in FIG. 10. CCN-U-1h with a new crystal structure shows a high absorbance and a blue-shift of absorption edge compared to gCN-U. The band gap of CCN-U-1h is determined to be 2.84 eV, which is a little larger than that of gCN-U (2.78 eV).

TABLE 3
The porous textures, C/N atomic ratios and photocatalytic
H₂ evolution activity of CCN-Us and gCNU synthesized at 550° C.

| | Porous texture | | carbon | Photocatalytic H₂ evolution activity | |
|---|---|---|---|---|---|
| | S_{BET} | Vₜₒₜ | nitride | Evolution rate | Amount of H₂ |
| Samples | (m²/g) | (mL/g) | ratio | (μmol/h) | evolved in 5 h (μmol) |
| CCN-U-1 h | 31 | 0.14 | C₃N_{4.3} | 1128 | 4757 |
| CCN-U-3 h | — | — | C₃N_{4.3} | 12 | 47 |
| gCN-U | 64 | 0.26 | C₃N_{4.6} | 470 | 2163 |

The porous textures such as the specific surface area and the total pore volumes of CCN-Us together with gCN-U are summarized in Table 3. The BET specific surface area and pore volume of CCNU-1h are 31 m²/g and 0.14 mL/g, which are smaller than those of gCN-U (64 m²/g and 0.26 mL/g) but higher than that of SCCN-TU samples (Table 2).

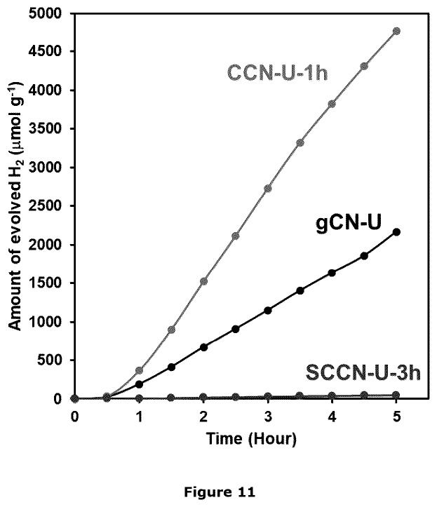

The photocatalytic H₂ evaluation of the synthesized CCN-Us and gCN-U loaded with 3 wt % Pt as a cocatalyst is carried out in 100 mL of 10 Vol % triethanolamine aqueous solution under the solar simulated light with 0.1 W/cm². The time course of photocatalytically evolved H₂ for the samples is displayed in FIG. 11. The H₂ production rate of CCNU-1h is 1128 μmol·g⁻¹h⁻¹ which is significantly higher than that of gCN-U (470 μmol·g⁻¹h⁻¹). However, CCN-U-3h shows drastically decreased photocatalytic activity (12 μmol·g⁻¹h⁻¹) compared to CCNU-1h, indicating that the optimal reaction time is 1 h for the synthesis of CCN-U. This result reveals that CCN with new crystalline structure synthesized from urea shows the high photocatalytic H₂ evolution activity. However, the activity is much less than that of SCCN-TU and MSCCN-TU samples, revealing the importance of sulphur doping and the mesoporosity in the final prepared samples with high crystallinity.

CCN from 3-Amino-1,2,4-Triazole (CCN-AT)

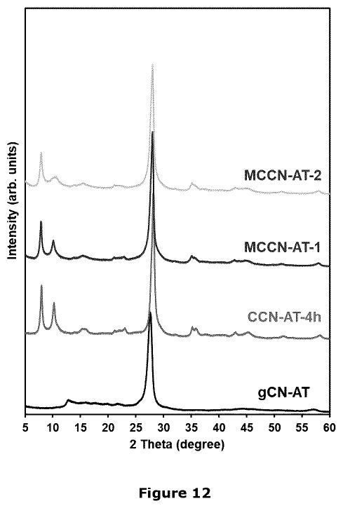

3-amino-1,2,4-triazole (AT) with heterocyclic ring and a high N content was also used as the carbon nitride precursor. This precursor was mixed with the KCl and thermally polymerized at 550° C. for 4 h. The X-ray diffraction patterns for the samples are displayed in FIG. 12. CCN-AT-4h shows several major peaks at the 2theta values of 7.86°, 10.10°, and 28.01° and a few minor peaks at higher angles. The peak positions of the sample are completely different from that of graphitic carbon nitride with amorphous structure prepared without KCl (gCN-AT), which shows (110) and (002) peaks,¹² indicating that carbon nitride with a new crystal structure is formed from AT under KCl salt condition. Mesoporosity can be generated when the silica nanoparticles are added to the synthesis mixture. The XRD pattern of the sample with the mesoporous structure prepared from AT (MCCN-AT) is similar to that of CCN-AT which does not have the mesoporous structure, revealing that the introduction of mesoporosity does not affect the crystallinity of the prepared samples with AT. To obtain the tunable mesoporosity, the molar ratio of the AT and silica nanoparticles is varied from 1 to 2. As can be seen in FIG. 12, the peaks that appeared at higher angles are almost the same for both the samples, revealing that the crystallinity is not affected in these samples.

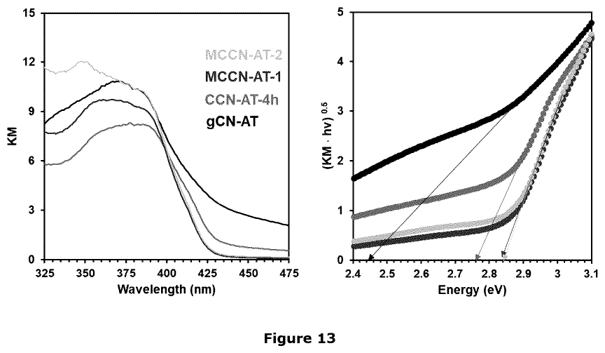

The optical property of MCCN-ATs together with CCN-AT-4h and gCN-AT were analysed by the UV-Vis spectrophotometer and their spectra are plotted in FIG. 13. The absorption edge of mesoporous carbon nitrides such as MCCN-AT-1 and MCCN-AT-2 is blue-shifted compared to that of CCN-AT-4h. The band gap of MCCN-AT-1 and MCCN-AT-2 are determined to be 2.84 eV, which are larger than that of CCN-AT-4h (2.76 eV). The increased band gap is caused by the reduced crystalline size through the formation of porous structure. It should be noted that the absorbance in the UV region for the mesoporous CCN-AT is higher than that of nonporous CCN-AT samples, which is quite the opposite of what we observed for the samples prepared with urea and thiourea.

TABLE 4
The textural parameters including the specific surface area, pore volume,
carbon nitride ratio, and photocatalytic H₂ evolution activity of
carbon nitrides with a new crystal structure synthesized from 3-amino-
1,2,4-triazole and KCl via hard template method at 550° C.

| | | | | Photocatalytic H₂ evolution activity | |
|---|---|---|---|---|---|
| | Porous texture | | carbon | | Amount of H₂ |
| | S_{BET} | Vₜₒₜ | nitride | Evolution rate | evolved in 5 h |
| Samples | (m²/g) | (mL/g) | ratio | (μmol · g⁻¹h⁻¹) | (μmol · g⁻¹) |
| CCN-AT-4 h | 5 | 0.01 | C₃N_{4.3} | 1625 | 6386 |
| MCCN-AT-1 | 65 | 0.14 | C₃N_{4.3} | 2649 | 10303 |
| MCCN-AT-2 | 214 | 0.32 | C₃N_{4.3} | 2690 | 10780 |
| gCN-AT | 13 | 0.07 | C₃N_{4.6} | 270 | 1135 |

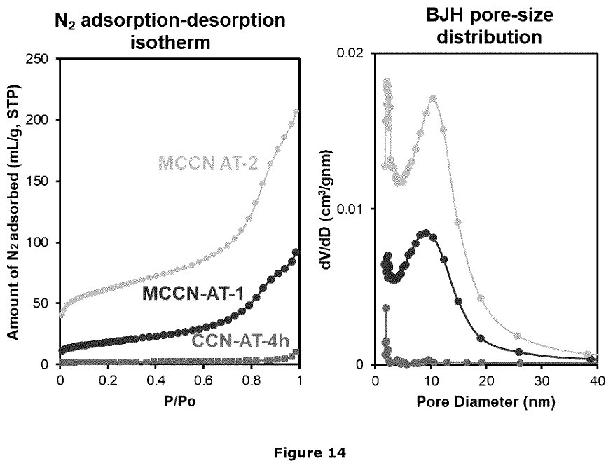

The specific surface area and the total pore volumes of MCCN-ATs synthesized from 3-amino-1,2,4-triazole and KCl via a hard template method and CCN-AT-4h and gCN-AT are analysed from the N₂ adsorption isotherm analysis and the evaluated values are summarized in Table 4. N₂ adsorption isotherms and BJH pore-size distribution curves are displayed in FIG. 14. The BET (Brunauer-Emmett-Teller) specific surface area and pore volume of MCCN-AT-1 and MCCN-AT-2 are 65 m²/g and 0.14 mL/g, and 214 m²/g and 32 mL/g, respectively, which are significantly larger than those of CCN-AT-4h (5 m²/g and 0.01 mL/g), revealing that mesoporosity significantly increased the specific surface area and the specific pore volume of the materials. In addition, BJH pore size distribution analysis reveals that mesoporous CCN-ATs such as MNCNAT-1 and MNCNNAT-2 have ˜11 nm of pore size, which is almost similar to the size of used SiO₂ nanoparticle as a template (12 nm). This reveals that the pore size of the samples can be controlled with a simple adjustment of the size of the silica nanoparticles. Other mesoporous structured templates such as SBA-15, KIT-6, SBA-1, SBA-16 may also be used as the templates to fabricate these nanostructures.

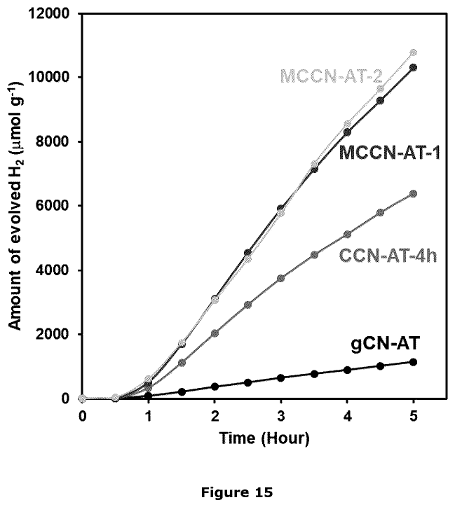

The photocatalytic activity of carbon nitride for H₂ evolution is strongly dependent on their crystal structure, crystallinity and surface area. The photocatalytic H₂ evaluation of the synthesized catalyst loaded with 3 wt % Pt as a cocatalyst is carried out in 100 mL of 10 Vol % triethanolamine aqueous solution under the solar simulated light with 0.1 W/cm². The time-course curves of photocatalytic H₂ evolution are displayed in FIG. 15. MCCN-AT-1 (2649 μmol·g⁻¹h⁻¹) and MCCN-AT-2 (2690 μmol·g⁻¹h⁻¹) with a new crystalline and mesoporous structure show higher photocatalytic activity for H₂ evolution than CCN-AT-4h (1625 μmol·g⁻¹h⁻¹). These values are almost 10 times higher than that of gCN-AT with graphitic carbon nitride structure (270 μmol·g⁻¹h⁻¹). MCCN-AT-1 and MCCN-AT-2 can photo catalytically produce 10303 μmol·g⁻¹ and 10780 μmol·g⁻¹ of H₂ from water in 5 h, respectively, which are significantly higher than CCN-AT-4h (6386 μmol·g⁻¹). However, the photocatalytic activity of MCCN-AT-2 is almost similar to that of MCCN-AT-1 while the specific surface area of the former (214 m²/g) is remarkably higher than that of the later (65 m²/g). It should be noted that MCCN-AT-2 registers the highest specific surface area among the samples with a high crystallinity and the mesoporosity prepared in this study. These results also reveal that the amount of template particles added in the synthesis is highly important to tune the textural properties of the final product. It was found that the optimal ratio of AT to SiO₂ is 2. It is also confirmed that the photocatalytic H₂ evolution of CCN-AT with a new crystalline structure can be highly enhanced by engineering its porous texture including the specific surface area, pore volume and pore diameter.

CCN from Aminoguanidine Hydrochloride (CCN-AG)

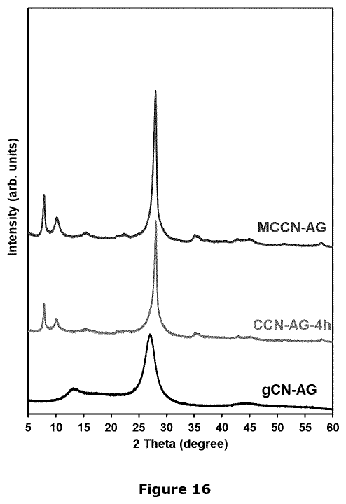

Non-cyclic and non-aromatic precursor with a high nitrogen content, such as aminoguanidine hydrochloride (AG) was also used for the preparation of novel crystalline carbon nitride through the salt moulding technique. Novel carbon nitride with a new crystal structure by the thermal polymerization with KCl and with and without SiO₂ nanoparticles as a hard template was prepared. Their crystal structures were analyzed by the X-ray diffraction analysis and the XRD patterns are plotted in FIG. 16. CCN-AG-4h and MCCN-AG do not show peaks at ˜13° and 27.3°, corresponding to (110) and (002) peaks of graphic carbon nitride (gCN-AG). However, these samples show new peaks that are observed at 7.86°, 10.10° and 28.01°, which are almost same as those of SCCN-TU-4h, indicating that CN with new crystal structure is formed from AG under KCl salt condition with and without SiO₂ nanoparticles used as hard template.

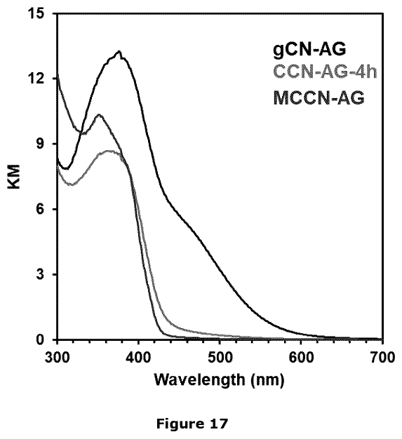

The optical property of CCN-AG-4h and MCCN-AG with a new crystal structure synthesized from AG and KCl with and without SiO₂ nanoparticles was analysed by the UV-Vis spectrophotometer. Their UV-Vis spectra are plotted in FIG. 17. The absorption edges of MCCN-AG and CCN-AG-4h are highly blue-shifted compared to that of gCN-AG. The bandgap energy of MCCN-AG and CCN-AG-4h is determined to be 2.82 eV and 2.73 eV, respectively, which are larger than that of gCN-AG (2.28 eV). It is assumed that the non-crystalline gCN-AG has a different molecular structure in the carbon nitride walls which absorbs more light in the visible region. It should also be noted that the salt moulding technique also supports the formation of a highly stable crystal structure which offers the band gap similar to that of the theoretically predicted carbon nitride with C₃N₄.¹⁰

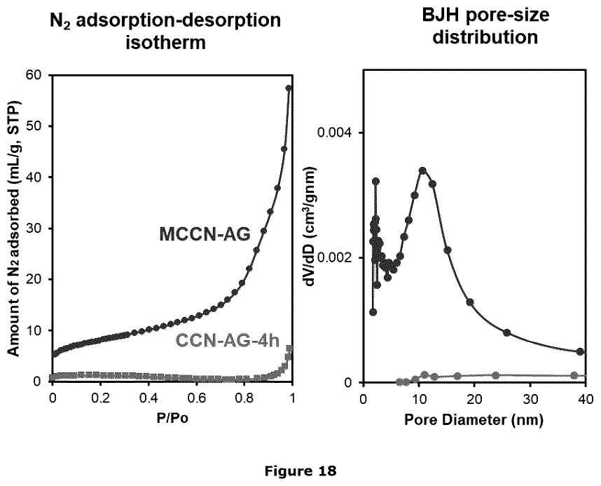

The porous textures such as the specific surface area and the total pore volumes of the carbon nitride samples synthesized from AG and KCl with and without silica nanoparticles are analysed from the N₂ adsorption-desorption isotherm analysis. The values are summarized in Table 5, and their N₂ adsorption isotherms and BJH pore-size distribution curves are plotted in FIG. 18. The BET (Brunauer-Emmett-Teller) specific surface area and pore volume of CCN-AG-4h (3 m²/g and 0.02 mL/g) are almost similar to those of graphitic carbon nitride prepared from AG (gCNAG; 3 m²/g and 0.02 mL/g). The specific surface area and the specific pore volume of mesoporous carbon nitride with new crystalline structure (MCCN-AG) is 29 m²/g and 0.09 mL/g, respectively. These values are much larger than those of CCN-AG-4h and gCN-AG due to the well-defined mesoporosity created through the hard templating approach using silica nanoparticles as the template. According to BJH pore size distribution analysis for MCCN-AG, the pore diameter of MCCN-AG is close to 12 nm which is similar to the diameter of the silica nanoparticles which were used as the templates. These results indicate that the hard templating process was quite successful and the mesopore diameter of these materials can be controlled with the simple adjustment of the particle diameter of the hard template. Similarly, ordered mesoporous structure can be introduced by changing the nature of the templates from silica nanoparticles to mesoporous silica with ordered porous structures such as SBA-15, SBA-16, SBA-1, KIT-5, KIT-6 and MCM-48. Initial results are interesting and further confirmed that ordered mesostructures can be introduced by using different mesoporous silica templates.

TABLE 5
The porous textures, C/N atomic ratios and photocatalytic H₂ evolution activity of carbon
nitrides with a new crystal structure synthesized from aminoguanidine hydrochloride
and KCl with and without SiO₂ nanoparticles at 550° C.

| | | | | Photocatalytic H₂ evolution activity | |
|---|---|---|---|---|---|
| | Porous texture | | carbon | | Amount of H₂ |
| | S_{BET} | Vₜₒₜ | nitride | Evolution rate | evolved in 5 h |
| Samples | (m²/g) | (mL/g) | ratio | (μmol · g⁻¹h⁻¹) | (μmol · g⁻¹) |
| CCN-AG-4 h | 3 | 0.02 | C₃N_{4.4} | 1423 | 5692 |
| MCCN-AG | 29 | 0.09 | C₃N_{4.4} | 1516 | 6477 |
| gCN-AG | 5 | 0.02 | C₃N_{4.5} | 98 | 420 |

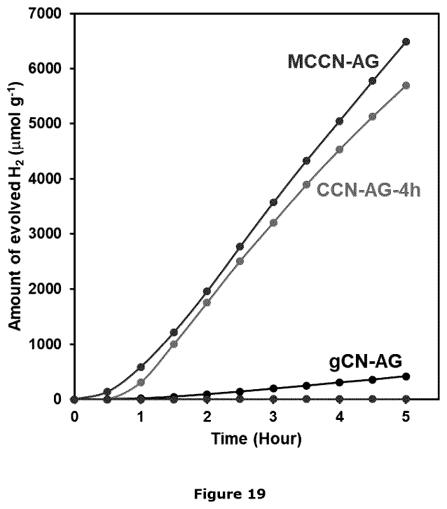

The time-course curves of photocatalytic H₂ evolution for the samples are displayed in FIG. 19. All the tested carbon nitrides samples can linearly produce H₂ gas after 1 h of light irradiation with increasing the irradiation time. CCN-AG-4h (1420 μmol/h/g) with a new crystalline structure shows an highly enhanced photocatalytic H₂ evolution activity compared to gCN-AG (100 μmol/h/g) while the bandgap energy of CCN-AG-4h (2.73 eV) is larger than that of gCN-AG (2.28 eV), and their specific surface areas are almost similar. This result indicates that carbon nitride with a new crystalline structure has more efficient photocatalytic active sites than graphitic carbon nitride. MCCN-AG with porous structure (1516 μmol·g⁻¹h⁻¹) shows slightly higher photocatalytic activity for H₂ evolution than CCN-AG-4h (1423 μmol·g⁻¹h⁻¹). It should be noted that these values are almost 15 times higher than that of graphitic carbon nitride structure (98 μmol·g⁻¹h⁻¹). MCCN-AG and CCN-AG-4h can photo catalytically produce 6477 μmol·g⁻¹ and 5692 μmol·g⁻¹ of H₂ from water in 5 h, respectively. Although these samples show much higher hydrogen production through visible light photocatalysis, their activity is much lower than that of the MCCN-TU. Among the materials studied, the sulphur functionalized crystalline carbon nitride with mesoporous structure and highly crystalline carbon nitride framework showed extremely high photocatalytic activity for the water splitting under visible light.

### Photocatalytic H₂ Evolution in Salt Water for SCCN-TU Materials

### Photocatalytic H₂ Evolution of SCCN-TU in Different Alkaline Salts Water Condition

Among the samples prepared, MCCN-TU and SCCN-TU were found to be the best photocatalysts that are active in the visible region. The photocatalytic H₂ evolution reaction was tested in different salt water conditions such as 0.5M NaCl(aq), 0.25M K₂HPO₄(aq) and 0.5M KI(aq) over SCCN-TU. The photocatalytic reactions are carried out in a top-irradiation Pyrex reactor connected to a closed gas circulation and evacuation system. 0.1 g of SCCN-TU-4h sample was dispersed in 100 mL of 10 Vol % triethanolamine aqueous salt solution as a hole scavenger under stirring in a reactor. Pt cocatalyst (Pt/catalyst=3 wt %) is in-situ photodeposited on the carbonitride photocatalyst in the suspension during the photocatalytic reaction. In order to completely remove the air in the suspension, the reaction vessel was evacuated several times, and Ar gas was introduced to the reactor up to ˜50 torr. Then, solar simulated light with 1 sun power is irradiated on the suspension by using a Newport Class ABB solar simulator equipped with 450 W Xe lamp and 1.5 G air mass filter through a water filter to cut the infrared light with 0.1 W/cm². The reaction temperature is maintained at 25° C. by keeping the reactor in the water jacket controlled by a circulating chiller system. The evolved gas is periodically analyzed through the in-situ auto-injection system of gas chromatograph (PerkinElmer Clarus 580 GC) equipped with TCD detector and stainless steel column packed with Molecular Sieve 5 A, where Ar gas is used as a carrier gas.

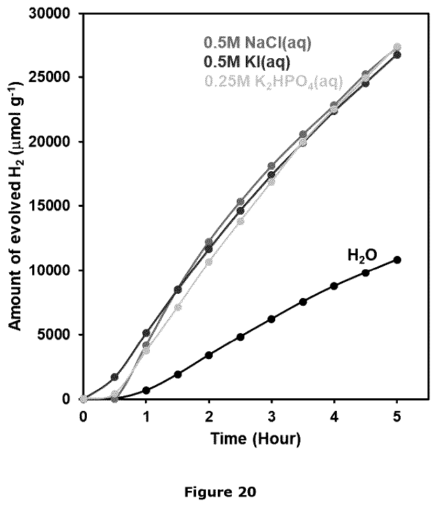

The time-course curves of photocatalytic H₂ evolution for SCCN-TU-4h in the different salt waters together with pure water are displayed in FIG. 20. The photocatalytic water splitting activity of SCCN-TU-4h under visible light increases with increasing the light irradiation under the solar simulated light. In pure water, H₂ evolution rate of SCCN-TU-4h is 2616 μmol·g⁻¹h⁻¹, which is higher than that of gCN-Bulk with graphitic carbon nitride structure (290 μmol·g⁻¹h⁻¹). In the salt solution, SCCN-TU-4h shows remarkably enhanced photocatalytic activity. In 0.5 NaCl (aq), SCCN-TU-4h can produce H₂ with a rate of 6510 μmol·g⁻¹h⁻¹ and the total evolved H₂ amount in 5 h is 27318 μmol·g⁻¹, while 10826 μmol·g⁻¹ in 5 h is produced in pure water. SCCN-TU-4h can also photo catalytically produce H₂ gas with a rate of 6379 μmol·g⁻¹h⁻¹ and 5906 μmol·g⁻¹h⁻¹ in 0.25M K₂HPO₄ (aq) and 0.5M KI (aq), respectively. SCCN-TU-4h also registers a highly enhanced photocatalytic H₂ evolution activity in the alkaline salt aqueous solutions. These results reveal that the synthesized novel catalysts are extremely active and break the record of all the photocatalytic visible active catalysts reported in the literature so far. This was possible because of the unique crystalline structure with a lot of vacant sites in the carbon nitride framework which are created by the salt moulding technique. It should also be mentioned that more than 85% of the salt in the seawater is NaCl as it is expected that the proposed catalyst may be well active for the splitting of seawater under visible light.

Comparison of Photocatalytic H₂ Evolution Activity of SCCN-TU-4h and Commercial TiO₂ Photocatalyst (P25).

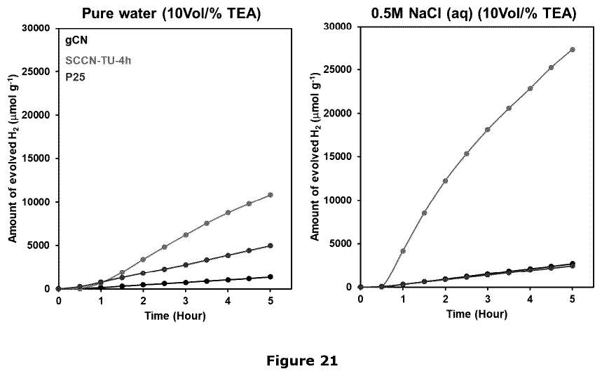

The high activity of photocatalytic H₂ production of SCCN-TU-4h can be revealed by comparing the activity with commercial TiO₂ photocatalyst (P25, Degussa) and gCN-Bulk in the pure water and 0.5M NaCl(aq) as simulated sea water condition under visible light. The photocatalytic H₂ evolution curves are displayed in FIG. 21. In the pure water, the H₂ evolution rates of SCCN-TU-4h, gCN and P25 are 2616 μmol·g⁻¹h⁻¹, 1020 μmol·g⁻¹h⁻¹ and 290 μmol·g⁻¹h⁻¹. In the simulated sea water (0.5M NaCl(aq)), the rate of SCCN-TU-4h is 6510 μmol·g⁻¹h⁻¹, which is more than 22 times higher than in pure water. The photocatalytic H₂ evolution rate of gCN-Bulk in seawater is also more than 6 times higher than in pure water. However, in case of P25 in the simulated sea water (0.5M NaCl(aq)), the H₂ evolution rate is 530 μmol·g⁻¹h⁻¹, which is ca. 12 times lower than that of SCCN-TU-4h. These results reveal the significant performance of SCCN-TU-4 in splitting seawater under visible light.

### Photocatalytic H₂ Evolution Activity of SCCN-TU-4h in Different Concentration of Pt Used as a Cocatalyst in 10 Vol % TEA in 0.5M NaCl (Aq).

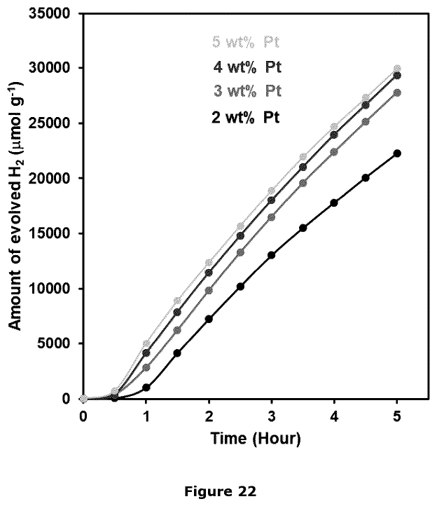

In order to optimize the loading amount of Pt used as cocatalyst, 2˜5 wt % Pt were in-situ photodeposited on SCCN-TU-4h in 10 vol % TEA in 0.5M NaCl(aq) under the solar simulated light. As can be shown in FIG. 22, 2 wt % Pt, 3 wt % Pt, 4 wt % Pt and 5 wt % Pt loaded on SCCNTU-4h can produce H₂ with a rate of 5380 μmol·g⁻¹h⁻¹, 6510 μmol·g⁻¹h⁻¹, 6740 μmol·g⁻¹h⁻¹ and 6800 μmol·g⁻¹h⁻¹, respectively, the evolved H₂ amount in 5 h is 22250 μmol·g⁻¹, 27790 μmol·g⁻¹, 29340 μmol·g⁻¹ and 29980 μmol·g⁻¹, respectively. With increasing the amount of Pt, the initial amount of evolved H₂ within 1 h is a little improved due to the fast photodeposition of Pt on the surface of SCCN-TU-4h. By changing the amount of Pt from 2 wt % to 3 wt %, the evolved H₂ amount is 25% increased. However, not much increase in the activity was observed when the amount of Pt was increased from 3 wt % to 5 wt % as only a slight increase in the H₂ evolution 7.8% was observed. In the view point of the cost of Pt, 3 wt % Pt is an optimum loading amount of Pt cocatalyst in 10 Vol % TEA in 0.5M NaCl(aq) for the photocatalytic H₂ production.

### Photocatalytic H₂ Evolution Activity of SCCN-TU-4h in Different Concentration of Triethanolamine in 0.5M NaCl (Aq).

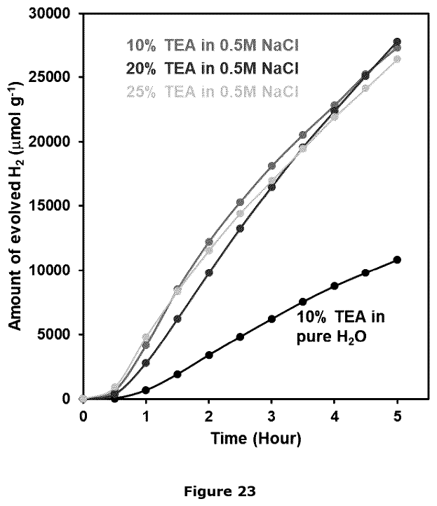

In order to optimize the concentration of triethanolamine (TEA) concentration in 0.5M NaCl(aq) for photocatalytic H₂ production of SCCN-TU-4h, the photocatalytic reaction was carried out in 0˜25 vol % TEA in 0.5M NaCl(aq). As shown in FIG. 23, SCCN-TU-4h shows the linear H₂ gas production after 1 h of light irradiation under the solar simulated light in these conditions. The H₂ evolution rates of SCCN-TU-4h in 0 vol %, 10 vol %, 20 vol % and 25 vol % TEA in NaCl(aq) are 2616 μmol·g⁻¹h⁻¹, 6510 μmol·g⁻¹h⁻¹, 6480 μmol·g⁻¹h⁻¹ and 5920 μmol·g⁻¹h⁻¹, respectively, and the evolved H₂ amount after 5 h are 10816 μmol·g⁻¹, 27318 μmol·g⁻¹, 27790 μmol·g⁻¹ and 26420 μmol·g⁻¹, respectively. In these conditions, photocatalytic H₂ evolution rate is almost similar. However, a more linearity in the hydrogen production over SCCN-TU-4h was observed in 20 Vol % TEA in 0.5M NaCl(aq) than in 10 vol % and 25 vol % TEA in 0.5M NaCl(aq).

### Photocatalytic H₂ Evolution Activity of SCCN-TU-4h in the Seawater Collected in Different Area Near Newcastle

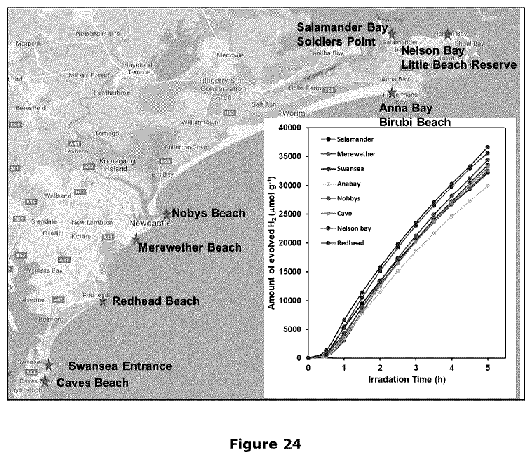

To understand the potential of the prepared catalysts for real world application, we investigated the photocatalytic H₂ production of SCCN-TU-4h in the seawater collected in a different area near Newcastle. The seawater is collected at Caves Beach, Swansea Entrance, Redhead Beach, Merewether Beach, Nobys Beach, Anna Bay Birubi Beach, Nelson Bay Little Beach Reserve and Salamander Bay Soldiers Point. The seawater was used after the filtering process with a nylon membrane filter with 0.4 μm pore size for removing particles and some algae in the water. The results are displayed in FIG. 24. SCCN-TU-4h can linearly produce H₂ gas in seawater collected from all different regions after 0.5 h of light irradiation under the solar simulated light. The hydrogen production rate of the SCCN-TU-4h in seawater is remarkably higher than in pure water. The average H₂ evolution rate of SCCN-TU-4h in these seawaters is 7790 (±400) μmol·g⁻¹h⁻¹. The average amount of evolved H₂ gas is calculated to be 33480 (±2080) μmol·g⁻¹ in 5 h in the seawater near Newcastle which is much higher than that in NaCl simulated water and pure water. Not much difference in the activity was observed when the seawater from different regions in Newcastle was used for this study, revealing that the prepared catalyst can be used for the generation of hydrogen from these seawater without any problem and will create a huge commercialization opportunity.

TABLE 6
Photocatalytic H₂ evolution activity of SCCN-TU-4 h in the
sea water collected from the different areas near Newcastle
including 20 vol % TEA and 3 wt % Pt as a cocatalyst.

| Area | Amount of H₂ evolved in 5 h (μmol g⁻¹) |
|---|---|
| Caves | 33070 |
| Swansea | 33540 |
| Redhead | 35580 |
| Mereweather | 32560 |
| Nobys | 34350 |
| Anna Bay | 29940 |
| Nelson Bay | 36630 |
| Salamanda Bay | 32170 |
| Average | 33480 |

### 5.6. Photocatalytic H₂ Evolution Activity of SCCN-TU-4h and MSCCN-TU in 0.5M NaCl (Aq).

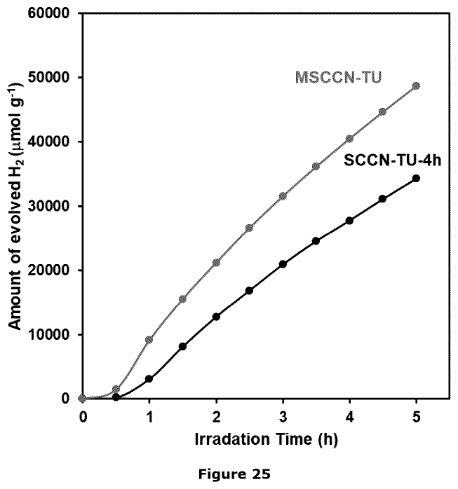

The photocatalytic H₂ production activity of SCCN-TU-4h can be enhanced by modifying the porous texture as shown in Table 2 in 10 vol % TEA (aq) with 3 wt % Pt as a cocatalyst. This phenomenon is also observed in the salt water condition. As shown in FIG. 25, MSCCN-TU with high specific surface area (61 m²/g) shows the highly enhanced activity in the simulated sea water (0.5M NaCl(aq)) containing 20 vol % TEA compared with SCCN-TU-4h (11 m²/g). The H₂ evolution rate and the amount of H₂ in 5 h for MSCCN-TU are 10974 μmol·g⁻¹h⁻¹ and 48612 μmol·g⁻¹, respectively, which are much higher than those of SCCN-TU-4h (8157 μmol·g⁻¹h⁻¹ and 34263 μmol·g⁻¹). The porous engineering of SCCN-TU can make 140% enhanced photocatalytic H₂ evolution activity. With this material, we evaluated the apparent quantum yield (AQY) by using the following equation,

AQY (%)=(Number of evolved H₂ molecules×2)/(Number of incident photons)×100

The number of incident photons irradiated to the reactor (55.4 cm²) were evaluated to be 1.56×10²¹ at 400-420 nm by using a Si photodiode power meter and 2 long-pass filters (λ>400 nm and λ>420 nm). The H₂ evolution rate of MSCCN-TU calculated with 3 wt % Pt under the irradiation of 400 nm<λ<420 nm (average 410 nm) is 2800 μmol·g⁻¹h⁻¹ in 0.5M NaCl(aq). The QY of MSCCN-TU is calculated to be 22.6% under 400 nm<λ<420 nm. AQY of other carbon nitride materials are summarized in Table 7. MSCCN-TU shows very high AQY which could be related with its large surface area and high crystallinity together with enhanced light absorption property compared with other carbon nitride materials even though the reaction conditions are different.

TABLE 7
The summary of photocatalytic activity of various carbon
nitride materials together with the reaction conditions.

| | carbon | | | Photocatalytic | |
|---|---|---|---|---|---|
| | nitride | Reaction | Light | H₂ evolution | AQY |
| | precursor | condition | source | Activity | (%) |
| ¹⁰Bulk gCN | Cyanamide | 100 mg catalyst | 300 W Xe | 10.7 | 0.1% |
| | | dispersed in | λ > 420 nm | μmol · h⁻¹ | (420 nm- |
| | | 100 mL of 10 | | | 460 nm) |
| | | vol % TEA(aq) | | | |
| | | 3 wt % Pt as a | | | |
| | | cocatalyst | | | |
| ¹³Mesoporous | Cyanamide | 100 mg catalyst | 500 W Hg | 149 | — |
| gCN | | dispersed in | short-arc | μmol · h⁻¹ | |
| | | 100 mL of 10 | lamp | | |
| | | vol % TEA(aq) | λ > 420 nm | | |
| | | 3 wt % Pt as a | | | |
| | | cocatalyst | | | |
| ¹⁴S-doped | Thiourea | 100 mg catalyst | 300 W Xe | 136 | 5.3% at |
| Porous gCN | | dispersed in 100 | λ > 420 nm | μmol · h⁻¹ | 420 nm |
| | | mL of 15 vol % | | | |
| | | TEA(aq) | | | |
| | | 3 wt % Pt as a | | | |
| | | cocatalyst | | | |
| ¹⁵CNNS | Melamine | 50 mg catalyst | λ > 420 nm | 53 | 8.57% at |
| | | dispersed in | | μmol h⁻¹ | 420 nm |
| | | 100 mL of 10 vol % | | | |
| | | MeOH(aq) | | | |
| | | 3 wt % Pt as a | | | |
| | | cocatalyst | | | |
| MSCCN-TU | Thiourea | 100 mg catalyst | Solar | 1097 | 22.6% |
| (Present | | dispersed in 100 | simulator | μmol h⁻¹ | (400 nm- |
| Work) | | mL of 20 vol % | (450 W Xe) | | 420 nm) |
| | | TEA in 0.5M | with 1.5G | | |
| | | NaCl | air mass | | |
| | | 3 wt % Pt as a | filter | | |
| | | cocatalyst | (0.1 W/cm²) | | |

Triethanolamine and methanol are denoted as “TEA” and “MeOH”, respectively.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose.

Optional embodiments may also be said to broadly include the parts, elements, steps and/or features referred to or indicated herein, individually or in any combination of two or more of the parts, elements, steps and/or features, and wherein specific integers are mentioned which have known equivalents in the art to which the invention relates, such known equivalents are deemed to be incorporated herein as if individually set forth.

Although a preferred embodiment has been described in detail, it should be understood that modifications, changes, substitutions or alterations will be apparent to those skilled in the art without departing from the scope of the present invention.

Throughout this specification and the claims which follow, unless the context requires otherwise, the word “comprise”, and variations such as “comprised”, “comprises” or “comprising”, will be understood to imply the inclusion of a stated integer or step or group of integers or steps but not the exclusion of any other integer or step or group of integers or steps.

As used herein, a, an, the, at least one, and one or more are used interchangeably, and refer to one or to more than one (i.e. at least one) of the grammatical object. By way of example, “an element” means one element, at least one element, or one or more elements.

In the context of this specification, the term “about” is understood to refer to a range of numbers that a person of skill in the art would consider equivalent to the recited value in the context of achieving the same function or result.

The claims:

1. A process for the preparation of a crystalline carbon nitride, the process including the steps of:
a. providing a carbon nitride precursor material;
b. mixing the carbon nitride precursor material with a metal salt to form a first mixture; and,
c. thermally treating the first mixture to produce the crystalline carbon nitride.

2. The process according to claim 1, wherein the carbon nitride precursor is selected from: thiourea, urea, aminoguanidine hydrochloride, diaminotriazine, diaminotriazole, 5,5-dithiobis(1-phenyl-1H-tetrazole), dithiooxamide, and 3-amino-1,2,4-triazole.

3. The process according to claim 1, wherein the carbon nitride precursor is thiourea.

4. The process according to claim 1, wherein the metal salt is selected from: potassium chloride, sodium chloride, magnesium chloride, lithium chloride or a mixture thereof.

5. The process according to claim 1, wherein the carbon nitride precursor is mixed with the metal salt to form the first mixture in a weight ratio of about 4:0.5 to about 4:10.

6. The process according to claim 1, wherein the carbon nitride precursor is mixed with the metal salt to form the first mixture in a weight ratio of about 4:2 to about 4:5.

7. The process according to claim 1, wherein the carbon nitride precursor is mixed with the metal salt to form the first mixture in a weight ratio of about 4:3.

8. The process according to claim 1, wherein the first mixture is thermally treated during step c. at a temperature ranging from about 450° C. to about 700° C.

9. The process according to claim 1, wherein the first mixture is thermally treated during step c. at a temperature ranging from about 500° C. to about 600° C.

10. The process according to claim 1, wherein the first mixture is thermally treated during step c. at a temperature of about 550° C.

11. The process according to claim 1, wherein the first mixture is thermally treated during step c. for a period of time ranging from 1 hour to about 8 hours.

12. The process according to claim 1, wherein the first mixture is thermally treated during step c. for a period of time ranging from 3 hours to about 5 hours.

13. The process according to claim 1, wherein the first mixture is thermally treated during step c. for about 4 hours.

14. The process according to claim 1, wherein the crystalline carbon nitride produced in step c. is washed with an acidic solution to remove alkaline salts and by-products.

15. The process according to step 14, wherein the acidic solution includes hydrochloric acid.

16. The process according to claim 1, wherein mixing the carbon nitride precursor material with the metal salt to form the first mixture is in a dry form in step b.

17. The process according to claim 1, further comprising a soft templating technique or a hard templating technique to increase a mesoporosity of the crystalline carbon nitride.

18. The process according to claim 17, wherein the soft templating technique or the hard templating technique is employed during step b.

19. The process according to claim 18, comprising the hard templating technique in the form of mesoporous silica nanoparticles.

20. The process according to claim 19, wherein the mesoporous silica is added to the mixture including the carbon nitride precursor material with the metal salt in a colloidal solution at step b.

21. The process according to claim 20, wherein the colloidal solution includes water.

22. The process according to claim 20, wherein the colloidal solution is evaporated resulting in the first mixture in the form of a dry powder prior to step c.

23. The process according to claim 1, wherein the thermally treating the first mixture in step c. is conducted in an atmosphere selected from nitrogen, argon, helium or is conducted under vacuum.

24. A highly crystalline mesoporous sulphur functionalized carbon nitride with S_{BET} (m²/g) of between about 40 and about 70 m²/g.

25. The highly crystalline mesoporous sulphur functionalized carbon nitride of claim 24, with S_{BET} of about 60 m²/g.

26. A crystalline carbon nitride produced from the process according to claim 1.

27. Use of the carbon nitride according to claim 24 as a photocatalyst for production of hydrogen.

28. The use according to claim 27, wherein the production of hydrogen is from saline water including from seawater.
